(19) United States
(12) Patent Application Publication
(10) Pub. No.: US 2018/0216627 A1
(43) Pub. Date: Aug. 2, 2018

(54) IMPELLER BLADE WITH ASYMMETRIC THICKNESS

(71) Applicant: IHC Holland IE B.V., Sliedrecht (NL)

(72) Inventor: Edwin Albert Munts, Zwijndrecht (NL)

(73) Assignee: IHC Holland IE B.V., Sliedrecht, OT (NL)

(21) Appl. No.: 15/506,260

(22) PCT Filed: Aug. 24, 2015
(86) PCT No.: PCT/NL2015/050588

§ 371 Date: Feb. 24, 2017

(30) Foreign Application Priority Data
Aug. 26, 2014 (NL) 2013367

(51) Int. Cl. F04D 29/24

(52) U.S. Cl. CPC F04D 29/242; F05D 2240/306; F05D 2240/303

(57) ABSTRACT

A blade for an impeller comprises a blade with a front portion with a leading edge and a trailing portion with a trailing edge joined by spaced apart pressure and suction sides to form an exterior blade surface. The blade pressure side is formed from an outer envelope of a first blade profile aligned in a first position; and at least a part of the front portion of the blade suction side is formed by rotating the first blade profile around the leading edge to match an angle of the incoming flow at a lower flowrate condition of the impeller.

### BACKGROUND

Centrifugal pumps are typically designed for a specific flowrate and rotation speed. At this condition, referred to as the best efficiency point, the front portion of the impeller blades are aligned with the incoming flow, as shown in FIG. 1a.

Beyond the best efficiency point, a variety of different types of blades are designed for use in centrifugal pumps for better performance during different pumping conditions and situations. For example, a number of patents and applications discuss varying the blade design in attempts to reduce solids being pumped from attaching to one of the edges of the blade. One such application is U.S. Pat. App. Pub. No. 2014/0079558 A1, which shows an impeller that is specially suited for pumping fibrous suspensions, like paper making stock. The impeller is formed to have vanes with a rounding or thickened part with a thickness greater than the central region of the vane to avoid fibers adhering to the edge of the vane. Similarly, GB1412488 also addresses the problem of fibers adhering to the leading edge of a vane by thickening the leading edge such that the diameter is larger than the thickness of the rest of the vane.

U.S. Pat. No. 2,272,469 is another patent which discloses a centrifugal pump with a specific impeller designed to eliminate the possibility of solids being caught on the heels of the impeller blades. For this, the blades are formed with a rounded off relatively narrow leading edge that is sloped at an angle to the axis of the impeller. The blade then expands to a larger thickness and then narrow before merging into a configuration that is parallel with the axis of the impeller.

Other blade designs are for reducing stress in the blade. One such example of this is shown in DE4000657 which discloses a blade for an impeller that helps to reduce negative pressures on the suction side, particularly during a partial loading situation. This is done by thickening the suction side and giving it a concave contour in the initial region, up to one-third of the blade length.

While these blades are all designed to avoid problems under certain conditions (solids attaching to the blade or withstanding conditions and pressures that could damage the blade), none specifically address designing a blade for optimal performance in a variety of different flow conditions. Beyond the best efficiency point, in particular at lower flowrates, the blades are no longer aligned with the incoming flow. When the angle between the blade and the incoming flow becomes too large, flow separation will occur and the flow will no longer follow the blade contour, but will detach from the blade surface, as shown in FIG. 1b. Flow separation leads to high energy losses within the flow, reducing the pump's energy efficiency.

### SUMMARY OF THE INVENTION

According to a first aspect of the invention, a blade for an impeller comprises a blade with a front portion with a leading edge and a trailing portion with a trailing edge joined by spaced apart pressure and suction sides to form an exterior blade surface. The blade pressure side is formed from an outer envelope of a first blade profile aligned in a first position; and at least a part of the front portion of the blade suction side is formed by rotating the first blade profile around the leading edge to match an angle of the incoming flow at a lower flowrate condition of the impeller.

Such a blade with an asymmetric thickness, and being thicker on the suction side, results in a profile more resistant to flow separation within a larger working range. This resistance or elimination of flow separation around the blade results in a more efficient impeller.

According to an embodiment, the front portion of the suction side is thicker than the front portion of the pressure side.

According to an embodiment, the trailing portion of the blade has a uniform thickness between the suction side and the pressure side.

According to an embodiment, the portion of the blade suction side that is formed by rotating the first blade profile is about 3-12% of the blade length between the leading edge and the trailing edge.

According to an embodiment, the trailing portion of the suction side is formed from the outer envelope of the first blade profile aligned in the first position.

According to an embodiment, the suction side comprises a transition portion where the profile transitions from the blade profile at the front portion to the blade profile at the trailing portion. Optionally, the transition portion is about 30-70% of the blade length between the leading edge and the trailing edge.

According to an embodiment, the blade is curved from the leading edge to the trailing edge.

According to an embodiment, wherein the angle of rotation between the blade profile aligned in the first position and the blade profile rotated is about 10-30 degrees.

According to an embodiment, an impeller includes at least one blade. Optionally, the impeller can include a plurality of blades, preferably 3-7 blades. Optionally, the impeller can be part of a centrifugal pump. Further optionally, that centrifugal pump can be part of a vessel.

According to a second aspect of the invention, a method of forming a blade for an impeller comprises forming a pressure side of the blade from a first blade profile aligned for a set flow condition; forming a front portion of a suction side of the blade from the first blade profile rotated around a leading edge to align with incoming flow at a lower flowrate condition of the impeller; forming a trailing portion of the suction side of the blade from the first blade profile aligned for the set flow condition; and forming a transition portion between the front portion and the trailing portion of the suction side.

According to an embodiment, the front portion of the suction side of the blade comprises about 3-12% of the width of the blade between a leading edge and a trailing edge.

According to an embodiment, the transition portion of the suction side of the blade comprises about 30-70% of the width of the blade between a leading edge and a trailing edge.

### BRIEF DESCRIPTION OF THE DRAWINGS

FIG. 1a is a view of a prior art blade aligned to incoming flow.

FIG. 1b is a view of a prior art blade not aligned to incoming flow.

FIG. 2a is a cross-sectional view of an impeller blade.

FIG. 2b is a plot of blade profiles which form the impeller blade of FIG. 2a.

FIG. 2c is a combined plot of the blade profiles of FIG. 2b.

FIG. 3 is a cross-sectional view of an impeller with a plurality of blades.

### DETAILED DESCRIPTION

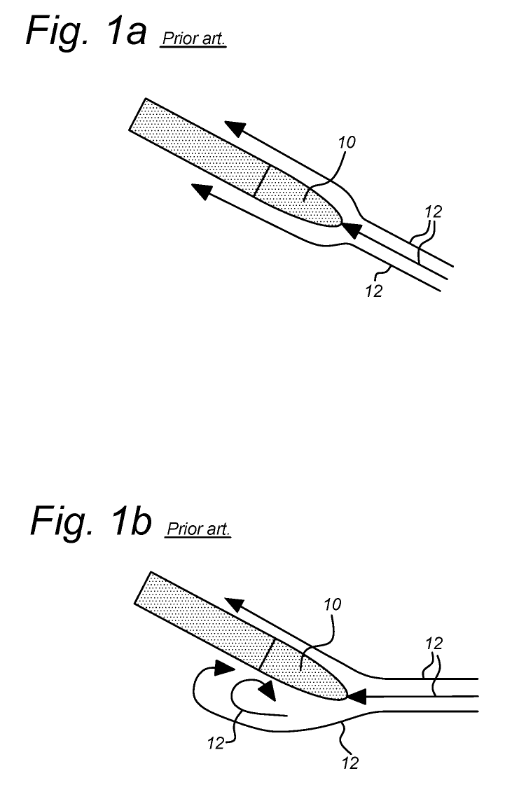

FIG. 1a is a view of a prior art blade 10 aligned to incoming flow, and FIG. 1b is a view of prior art blade 10 not aligned to incoming flow. FIGS. 1a-1b include arrows 12 indicating flow around blade 10. Blades for impellers are typically designed to align with a set incoming flowrate at a specific rotation speed, as shown in FIG. 1a. When a condition occurs where the blade is not aligned, either due to a different flowrate, a different rotation speed or both, flow separation can occur. This flow separation occurs when the angle between the blade and the incoming flow becomes too large, and causes the flow 12 to no longer follow blade 10 contour and detach from blade 10 surface. This flow separation, as shown in FIG. 1b, can result in high energy losses within the flow, significantly reducing the energy efficiency of the pump in which the blade and impeller rotate.

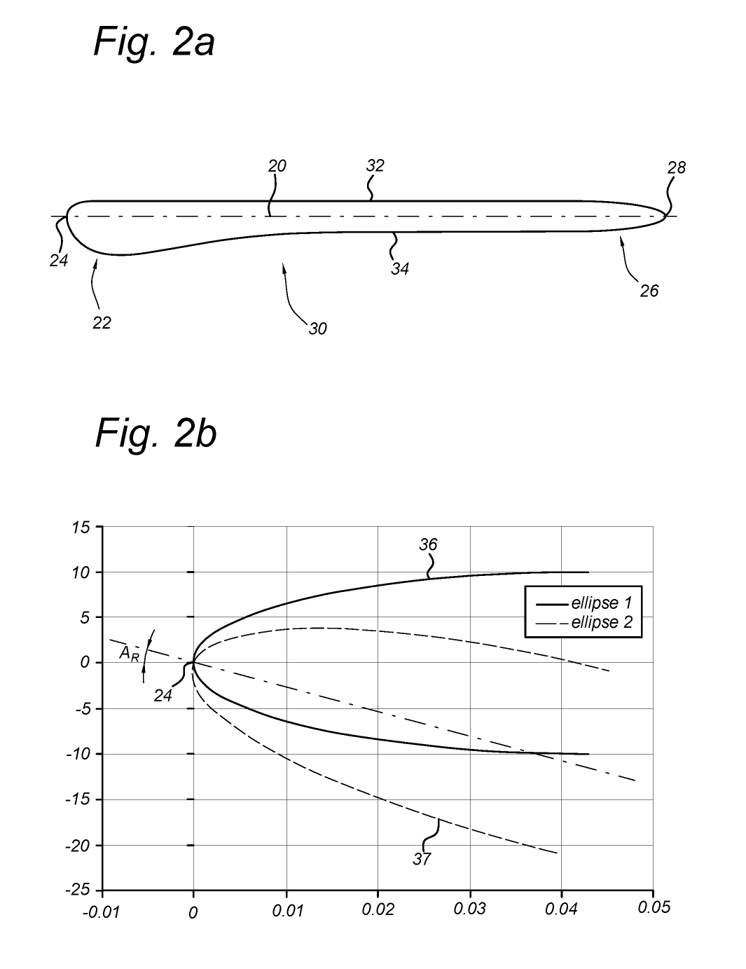

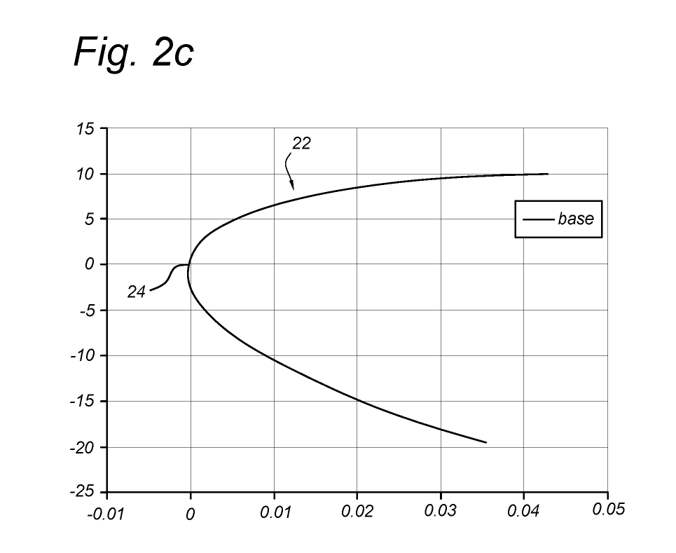

FIG. 2a is a cross-sectional view of an impeller blade 20 with a specific profile to encourage flow to remain attached to blade 20 surface within a working range of the pump. FIG. 2b is a plot of blade profiles 36, 37 which form blade 20, and FIG. 2c is a combined plot of the profiles of FIG. 2b. In use, blade 20 often has a curved profile. However, blade 20 is shown with a straight profile in FIGS. 2a-2c for simplicity of viewing.

Blade 20 includes front portion 22 with leading edge 24, trailing portion 26 with trailing edge 28, transition portion 30, pressure side 32 and suction side 34. Suction side 34 and pressure side 32 form the exterior surfaces of blade 20. In the embodiment shown, blade 20 is a solid blade, but other embodiments could have interior cavities or space(s).

Front portion 22 of blade 20 outer envelope is formed by blade profile 36 and 37, shown in FIG. 2b. Blade profile 36 is the design (at a first alignment position) of a blade profile to align flow and ensure that flow remains attached to the blade surface during a set operating condition. This can be based on, for example, the expected average flowrate and rotation speed for the impeller. Profile 37 is the same shape as profile 36, and is rotated at an angle of rotation A_{R} of about 20 degrees around leading edge 24. This rotation aligns profile to resist flow separation at a different flowrate condition of the impeller, for example a lower flowrate condition. This could be simply a lower flowrate expected to be experienced, the lowest flowrate of a working range of the impeller or another range. Blade 20 front portion 22 is then formed on pressure side 32 by blade envelope 36 and on suction side 34 by blade envelope 37. Front portion can be about 3-12% of blade between leading edge 24 and trailing edge 28.

Transition portion 30 is formed by transitioning suction side 34 from profile 37 to profile 36 between front portion 22 and trailing portion 26 of blade 20. This transition can be gradual and can include curvature on suction side 34. Transition portion 30 can make up about 20%-70% of blade 20 between leading edge 24 and trailing edge 28.

Trailing portion 26 is formed by profile 36 (at the first alignment position) on both pressure side 32 and suction side 34. Trailing portion 26 forms the rest of the blade 20 after front portion 22 and transition portion 30.

The combination of profiles 36 and 37 at front portion 22 results in blade 20 having an asymmetric thickness between pressure side 32 and suction side 34, with suction side 34 being thicker than pressure side 32 for front portion 22 and into transition portion 30. By forming blade 20 in this manner, blade 20 is better able to resist flow separation. As mentioned above, at lower flowrates, separation often occurs on the suction side of a blade (see FIG. 1b). By forming suction side 34 of front portion 22 of blade 20 with rotated profile 37 (aligned for different flow conditions), blade 20 resists flow separation and the consequent drops of efficiency due to flow separation. Using a first aligned profile 36 to form pressure side 32 and the rotated profile 37 to form suction side 34 at the front portion makes blade 20 more resistant to flow separation over a larger working range of the blade 20.

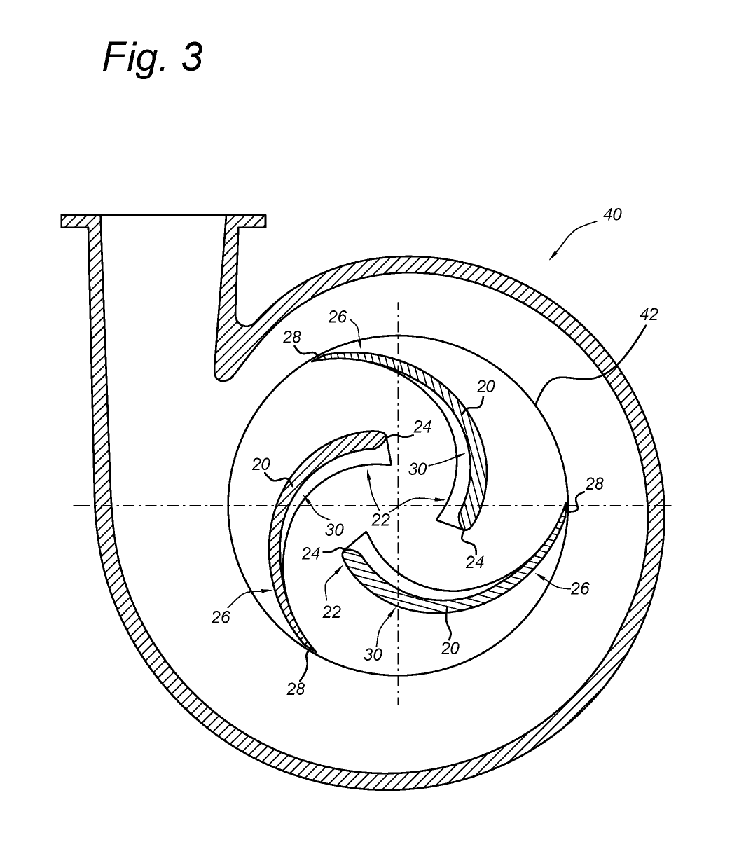

FIG. 3 is a cross-sectional view of pump 40 with impeller 42 with a plurality of blades 20. Impeller 42 includes three blades 20, which are curved in shape. Blades 20 each include front portion 22 with leading edge 24, trailing portion 26 with trailing edge 28, transition portion 30, pressure side 32 and suction side 34. Each of blades 20 is formed according to blade 20 shown in FIGS. 2a-2c, with front portion 22 formed on pressure side 32 from profile 36 and on suction side 34 from rotated profile 37, resulting in asymmetric blade 20 thickness with the suction side 34 being thicker in the front portion 22.

By forming front portions 22 of blades 20 outer envelope with profile 36 on pressure side 32 and with rotated profile 37 on suction side 34, blade 20 can better resist flow separation over a larger working range of impeller 42 and pump 40. By keeping flow along the contour of blade 20, energy losses due to flow separation can be reduced or eliminated, resulting in a more efficient pump 40 and a larger efficient working range for impeller 42. Blade 20 is better able to resist flow separation in a larger range than past blades designed and aligned for a single flowrate and rotation speed. Additionally, as blade 20 wear is significant at leading edge 24, the extra thickness of blade 20 in front portion 22 can resist this wear and thereby increase the lifespan of blade 20, impeller 42 and pump 40.

While pump 40 is shown with an impeller 42 with three blades 20, impeller 42 could have more or fewer blades, for example 3-7 blades. Additionally, the size, shape and curvature of blades 20 in FIGS. 2a-3 are shown for example purposes only and could vary in different systems. For example, blades could be similar to those shown in WO2012/074402 A1. The size of front portion 22, transition portion 30 and trailing portion 26 of blade 20 can also vary depending on system requirements. While the angle of rotation for profile 37 is said to be 20 degrees in FIG. 2b, this is for example purposes only. The angle could vary in other embodiments, and could be, for example, in the range of 10-30 degrees.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed, but that the invention will include all embodiments falling within the scope of the appended claims.

1. A blade for an impeller, the blade comprising:
a front portion with a leading edge and a trailing portion with a trailing edge joined by spaced apart pressure and suction sides to form an exterior blade surface;
wherein the pressure side is formed from an outer envelope of a first blade profile aligned in a first position; and
wherein at least a part of the front portion of the suction side is formed by rotating the first blade profile around the leading edge to match an angle of the incoming flow at a lower flowrate condition of the impeller.

2. The blade of claim 1, wherein the front portion of the suction side is thicker than the front portion of the pressure side.

3. The blade of claim 1, wherein the trailing portion of the blade has a uniform thickness between the suction side and the pressure side.

4. The blade of claim 1, wherein the portion of the blade suction side that is formed by rotating the first blade profile is about 3-12% of the blade length between the leading edge and the trailing edge.

5. The blade of claim 1, wherein the trailing portion of the suction side is formed from the outer envelope of the first blade profile aligned in the first position.

6. The blade of claim 1, wherein the suction side comprises a transition portion where the profile transitions from the blade profile at the front portion to a blade profile at the trailing portion.

7. The blade of claim 6, wherein the transition portion is about 30-70% of the blade length between the leading edge and the trailing edge.

8. The blade of claim 1, wherein the blade is curved from the leading edge to the trailing edge.

9. The blade of claim 1, wherein the angle of rotation is about 10-30 degrees.

10. An impeller comprising at least one blade according to claim 1.

11. A centrifugal pump comprising the impeller of claim 10.

12. A vessel, comprising a centrifugal pump according to claim 11.

13. A method of forming a blade for an impeller, the method comprising:
forming a pressure side of the blade from a first blade profile aligned for a set flow condition;
forming a front portion of a suction side of the blade from the first blade profile rotated around a leading edge to align with incoming flow at a lower flowrate condition of the impeller;
forming a trailing portion of the suction side of the blade from the first blade profile aligned for the set flow condition; and
forming a transition portion between the front portion and the trailing portion of the suction side.

14. The method of claim 13, where the front portion of the suction side of the blade comprises about 3-12% of the width of the blade between a leading edge and a trailing edge.

15. The method of claim 13, wherein the transition portion of the suction side of the blade comprises about 30-70% of the width of the blade between a leading edge and a trailing edge.
